(19) United States
(12) Patent Application Publication
(10) Pub. No.: US 2026/0329582 A1
(43) Pub. Date: Oct. 22, 2026

(54) SCALABLE GENERATION OF APPLICATION PROGRAMMING INTERFACE (API) DOCUMENTATION USING SPLIT-AND-MERGE ALGORITHM AND ARTIFICIAL INTELLIGENCE

(71) Applicant: BOOMI, LP, Conshohocken, PA (US)

(72) Inventors: Souvik CHOWDHURY, West Bengal (IN); Ashish MISHRA, Uttar Pradesh (IN); Nikhil KALYANKAR, Telangana (IN); Subhadeep KHAN, Karnataka (IN)

(73) Assignee: BOOMI, LP, Conshohocken, PA (US)

(21) Appl. No.: 19/185,936

(22) Filed: Apr. 22, 2025

(51) Int. Cl. G06F 8/73

(52) U.S. Cl. CPC G06F 8/73

(57) ABSTRACT

State-of-the-art automated techniques for generating application programming interface (API) documentation are not scalable as the number and sizes of application programming interfaces increase. Accordingly, disclosed embodiments provide scalable generation of API documentation using a split-and-merge algorithm and artificial intelligence (e.g., a generative artificial intelligence model, such as a large language model) for technically detailed types of API documentations. In addition, disclosed embodiments may utilize a key-endpoint shortlisting algorithm, along with the same artificial intelligence, for high-level types of API documentation.

### BACKGROUND

### Field of the Invention

The embodiments described herein are generally directed to artificial intelligence (AI), and, more particularly, to the scalable generation of application programming interface (API) documentation using a split-and-merge algorithm and artificial intelligence.

### Description of the Related Art

Virtually every modern software application provides an application programming interface (API). An application programming interface is a software interface, comprising a set of rules, protocols, and/or tools, that enables the software application to communicate with other software applications (i.e., “clients”), and stands in contrast to a user interface, which enables the software application to communicate with a human user. The application programming interface defines how requests from clients and responses from the software application should be formatted and processed, enabling developers to integrate their clients with the software application.

A typical application programming interface for a software application may define at least one base uniform resource locator (URL) and one or more paths, one or more methods, an output format for responses, an authentication and/or authorization protocol, headers, rate limiting, error handling, and/or other API components. Each path defines a resource of the software application. The base URL in combination with an appended path represents a full URL, which may be referred to as an “endpoint.” It should be understood that there is a direct correspondence between endpoints (i.e., generally referring to the full URL) and paths (i.e., generally referring to the differentiating portion of the full URL), and therefore, the terms “endpoint” and “path” may be used interchangeably herein. The methods may comprise or consist of the HyperText Transfer Protocol (HTTP) methods, including GET, POST, PUT, and/or DELETE, and/or other sets of methods. A call to the application programming interface may comprise or consist of a combination of one of the methods with one of the endpoints, so as to perform the chosen method on the resource at the chosen endpoint. Examples of output formats include, without limitation, eXtensible Markup Language (XML), JavaScript Object Notation (JSON), Simple Object Access Protocol (SOAP), and the like. Examples of authentication protocols include, without limitation, API keys, Open Authorization (OAuth), JSON web tokens, basic authentication, and the like.

Each application programming interface is generally defined by an API specification, which ideally, but not necessarily, specifies each component of the application programming interface. Some API specifications are very large. These API specifications may potentially contain hundreds or thousands of paths. Since it can be cumbersome to review and understand such a large API specification, especially for non-technical users (e.g., product managers, business leaders, etc.), it is generally beneficial to draft an API documentation that summarizes the API specification for such users.

Given the exponential increase in application programming interfaces, there is a need to automate the generation of API documentations. In the state of the art, automated API-documentation techniques rely on annotation-based natural language processing (NL P) models for content extraction and document generation. However, these state-of-the-art techniques are time-consuming, are primarily focused on technically detailed documentation, which is not helpful for non-technical users, and lack adaptability for the needs of different users (e.g., technical vs. non-technical users). For instance, state-of-the-art solutions struggle to generate concise or business-focused summaries, alongside technical documentation, which makes it difficult to provide tailored documentation for different stakeholders. In addition, these state-of-the-art techniques are not scalable for large API specifications, which frequently results in performance issues and incomplete API documentation.

### SUMMARY

Accordingly, systems, methods, and non-transitory computer-readable media are disclosed for the scalable generation of application programming interface (API) documentation using a split-and-merge algorithm and artificial intelligence.

In an embodiment, a method comprises using at least one hardware processor to: receive an application programming interface (API) specification that defines an application programming interface, including a plurality of endpoints; determine a type of API documentation, to be generated for the API specification, from among a plurality of types of API documentation; when the determined type of API documentation is a first type, perform a first process comprising selecting one or more endpoints from the plurality of endpoints, generating a prompt based on the selected one or more endpoints, and inputting the prompt to a large language model to produce the API documentation; when the determined type of API documentation is a second type, perform a second process comprising splitting the API specification into a plurality of portions, for each of the plurality of portions, generating the prompt based on the portion, and inputting the prompt to the large language model to produce an API sub-document, and merge the API sub-documents for the plurality of portions into the API documentation; and output the API documentation.

The method may further comprise using the at least one hardware processor to: determine whether or not the application programming interface is complex based on one or more criteria; when determining that the application programming interface is complex, perform either the first process or the second process based on the determined type of API documentation; and when determining that the application programming interface is not complex, without performing either the first process or the second process, generate the prompt based on the API specification, and input the prompt to the large language model to produce the API documentation. The one or more criteria may comprise a number of the plurality of endpoints satisfying a predefined endpoint threshold. The one or more criteria may comprise a number of tokens in the API specification satisfying a predefined token threshold. The one or more criteria may comprise both a number of the plurality of endpoints satisfying a predefined endpoint threshold and a number of tokens in the API specification satisfying a predefined token threshold.

The method may further comprise using the at least one hardware processor to format the API documentation prior to outputting the API documentation.

The second process may further comprise, for each of the plurality of portions: when the portion is a first portion, determine a structure of the API sub-document for the first portion; and when the portion is a subsequent portion to the first portion, generate the prompt based on the subsequent portion and the determined structure of the API sub-document for the first portion. The plurality of portions may comprise a plurality of subsequent portions, wherein the plurality of subsequent portions are processed in parallel.

The first type of API documentation may represent a plurality of use cases. The plurality of use cases may comprise a technical summary and a business overview. The second type of API documentation may represent at least one use case, wherein the at least one use case comprises a technical detail.

Each of the plurality of endpoints nay represent one of a plurality of paths, wherein selecting one or more endpoints from the plurality of endpoints comprises: calculating a combined count for each of the plurality of paths; sorting the plurality of paths according to the combined counts for the plurality of paths; calculating a number of top paths to select; selecting a set of one or more top paths from the sorted plurality of paths according to the calculated number of top paths to select; and returning the selected set of one or more top paths as the selected one or more endpoints. For each of the plurality of paths, the combined count for that path may be calculated as a sum of a number of operations for that path and a number of schemas for that path.

Each of the plurality of endpoints may represent one of a plurality of paths, wherein splitting the API specification into a plurality of portions comprises: generating a document for each of a plurality of subsets of one or more of the plurality of paths, wherein the plurality of subsets collectively comprise all of the plurality of paths; and for each of the plurality of subsets, for each path in the subset, parse a definition of the path to identify one or more API components of the path, and add information for the identified one or more API components from the API specification to the document for the subset; wherein each document represents one of the plurality of portions. Each of the plurality of subsets may consist of a single one of the plurality of paths.

The method may further comprise determining a use case for the API documentation, wherein each generation of the prompt comprises selecting a predefined template for the prompt from a plurality of predefined templates, based on the use case.

The method may be implemented by an artificial intelligence (AI) agent hosted within a computing environment. The computing environment may be an integration platform as a service (iPaaS) platform.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example process for scalable generation of application programming interface (API) documentation, according to an embodiment; and

FIG. 4 illustrates an example process for key-endpoint shortlisting, according to an embodiment.

### DETAILED DESCRIPTION

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

In an embodiment, systems, methods, and non-transitory computer-readable media are disclosed for the scalable generation of application programming interface (API) documentation using a split-and-merge algorithm and artificial intelligence (AI). A comprehensive API-documentation generator is disclosed that provides a single source that is capable of generating API documentation for a plurality of use cases, from low-level technical detail to a high-level business overview, and anywhere in between and beyond. Thus, the API-documentation generator can tailor the API documentation to different target groups, such as a technical detail for core technical teams, a technical summary for product managers, and a business overview for business leaders, while improving accessibility and decision-making for all target groups. In an embodiment, a split-and-merge algorithm enables the API-documentation generator to efficiently scale to infinitely large API specifications, while ensuring the clarity and usability of the resulting API documentation, by splitting large API specifications into manageable portions for a generative AI model (e.g., large language model), and then reconstructing the portions into each API documentation. In addition, a key-endpoint-shortlisting algorithm may be employed, for higher level API documentations, to ensure that critical technical information is included. This approach ensures automated, structured, relevant, and scalable API documentation, and optimizes workflows across technical and business domains, thereby reducing manual effort and time, while maintaining high accuracy.

### 1. Infrastructure

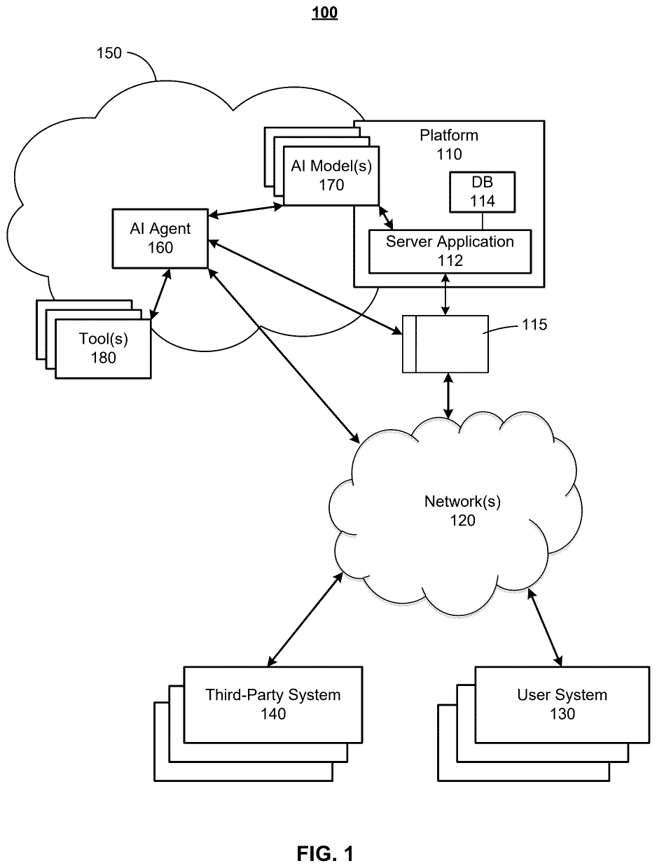

FIG. 1 illustrates an example infrastructure 100, in which one or more of the processes described herein may be implemented, according to an embodiment. Infrastructure 100 may comprise a platform 110 which hosts, supports, and/or executes one or more of the disclosed processes, which may be implemented in software and/or hardware. In particular, platform 110 may execute a server application 112, and/or host a database 114 that may store data used by server application 112. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and one or more user systems 130 and/or third-party systems 140. Network(s) 120 may comprise the Internet, and communication through network(s) 120 may utilize standard transmission protocols, such as HTTP, HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 and/or third-party system(s) 140 through a single set of network(s) 120, it should be understood that platform 110 may be connected to different user systems 130 and/or third-party systems 140 via different sets of one or more networks. For example, platform 110 may be connected to a subset of user systems 130 and/or third-party systems 140 via the Internet, but may be connected to another subset of user systems 130 and/or third-party systems 140 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal computer or professional workstation of a team member or other stakeholder, in the development of a software application, who has a user account for accessing server application 112 on platform 110. It should be understood that the user may be anywhere from an expert software engineer, with extensive knowledge of application programming interfaces, to a business decision-maker, lay person, or other non-technical person, with little to no knowledge of application programming interfaces. Each user account may be associated with an overarching organizational account for managing software applications being developed by an organization using platform 110.

Server application 112 may manage a computing environment 150. In particular, server application 112 may provide a user interface 115 and backend functionality, including one or more of the processes disclosed herein, to enable users, via user systems 130, to construct, develop, modify, save, delete, test, deploy, un-deploy, and/or otherwise manage software applications within computing environment 150. User interface 115 may comprise a graphical user interface that implements a low-code environment, including potentially a no-code environment, in which users may construct software applications.

The user of a user system 130 may authenticate with platform 110 using standard authentication means, to access server application 112 in accordance with permissions or roles of the associated user account. The user may then interact with server application 112 to manage one or more software applications, for example, within a larger software platform within computing environment 150. It should be understood that multiple users, on multiple user systems 130, may manage the same software applications and/or different software applications in this manner, according to the permissions or roles of their associated user accounts.

In an embodiment, platform 110 may be an integration platform as a service (iPaaS) platform. In this case, the software application(s) being developed may be integration process(es). Computing environment 150 may comprise one or a plurality of integration platforms that each comprises one or a plurality of integration processes. Each integration platform may be associated with an organization, which may be associated with one or more user accounts by which respective user(s) manage the organization's integration platform, including the various integration process(es). An integration process may represent a transaction involving the integration of data between two or more systems, and may comprise a series of elements that specify logic and transformation requirements for the data to be integrated. Each element, which may also be referred to as a “step,” may transform, route, and/or otherwise manipulate data to attain an end result from input data. For example, a basic integration process may receive data from one or more data sources (e.g., via an application programming interface of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

The functionality of server application 112 may include a process for constructing an integration process within one or more screens of a graphical user interface of user interface 115. Embodiments of such functionality are disclosed, for example, in U.S. Pat. No. 8,533,661, issued on Sep. 10, 2013, and U.S. Pat. No. 11,886,965, issued on Jan. 30, 2024, which are both hereby incorporated herein by reference as if set forth in full, and referred to hereafter as “the GUI applications.” In particular, the GUI applications describe functionality that enable the construction of integration processes on a virtual canvas. Typically, the construction of an integration process may require the incorporation of one or more application programming interfaces into one or more connector steps. Thus, the developer of an integration process may benefit from accurate API documentation of the implicated application programming interfaces.

Each integration process, when deployed, may be communicatively coupled to network(s) 120. For example, each integration process may comprise an application programming interface that enables clients to access an integration process via network(s) 120. A client may push data to an integration process through application programming interface, and/or pull data from an integration process through application programming interface.

One or more third-party systems 140 may be communicatively connected to network(s) 120, such that each third-party system 140 may communicate with an integration process in computing environment 150 via an application programming interface. Third-party system may host and/or execute a software application that pushes data to an integration process and/or pulls data from an integration process, via the application programming interface of the integration process. Additionally or alternatively, an integration process may push data to a software application on third-party system 140 and/or pull data from a software application on third-party system 140, via an application programming interface of the third-party system 140. Thus, third-party system 140 may be a client or consumer of one or more integration processes, a data source for one or more integration processes, and/or the like. As examples, the software application on third-party system 140 may comprise, without limitation, enterprise resource planning (ERP) software, customer relationship management (CRM) software, accounting software, and/or the like.

As mentioned above, each integration process and/or each third-party system 140 may provide an application programming interface. Each of these application programming interfaces will have an API specification. While an API specification may be understandable to a software engineer, it will generally not be understandable to non-technical users, such as a managers, business leaders, and other high-level decision-makers. Therefore, these non-technical users may be unable to grasp what the software application, to which the API specification pertains, does and/or how it might fit into the business of the organization.

Accordingly, platform 110 may comprise an automated API-documentation generator that automatically generates API documentations from API specifications. This API-documentation generator may be implemented in server application, for example, as an integrated tool that is available to users of platform 110. Alternatively, this API-documentation generator may be implemented as an artificial intelligence (AI) agent 160. As yet another alternative, the API-documentation generator may be a client-side software application that executes on a user system 130. In either case, the API-documentation generator may comprise or have access to one or more AI models 170 on platform 110 and/or in computing environment 150. In the case that the API-documentation generator is implemented as AI agent 160, AI agent 160 may also have access to one or more tools 180, internal and/or external to computing environment, which is each capable of performing a sub-task in support of API-documentation generation.

AI model(s) 170 may comprise one or more generative AI models, such as a generative language model (e.g., small language model, large language model, etc., that responds to natural-language prompts in natural language) to generate natural-language expressions, a generative image model (e.g., that responds to a natural-language prompt with an image) to generate diagrams, drawings, or other graphical elements, and/or the like. As used herein, the term “natural language” or “natural-language” refers to language, including grammar, that would be expected in a normal conversation between two humans. A pre-trained generative AI model may be used as a base model that is fine-tuned for the specific task of generating API documentation.

One well-known example of a large language model is the Generative Pre-trained Transformer (GPT). GPT-4 is the fourth-generation language prediction model in the GPT-n series, created by OpenAI of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the DeepSeek family of large language models from DeepSeek AI of Hangzhou, Zhejiang, China, any of the Claude family of large language models (e.g., Claude 3 Opus) developed by Anthropic PBC of San Francisco, California, the Falcon large language model (e.g., Falcon 160B) released by the United Arab Emirates' Technology Innovation Institute (TII), the Large Language Model Meta AI (LLaMA) model (e.g., LLAMA 2) released by Meta AI of New York, New York, the Gemini model, the Mistral family of models released by Mistral AI of Paris, France, and the like.

Examples of generative image models include, without limitation, the DALL-E family of models (e.g., DALL-E, DALL-E 2, or DALL-E 3) from OpenAI, Stable Diffusion (e.g., SD 3.5) from Stability AI Ltd of London, England, United Kingdom, Imagen (e.g., Imagen 3) from Google LLC of Mountain View, California, Midjourney form Midjourney, Inc. of San Francisco, California, Adobe Firefly from Adobe Inc. of San Jose, California, Picasso from Nvidia Corp. of Santa Clara, California, Runway Gen-2 from Runway AI, Inc. of New York City, New York, and the like.

### 2. Example Processing System

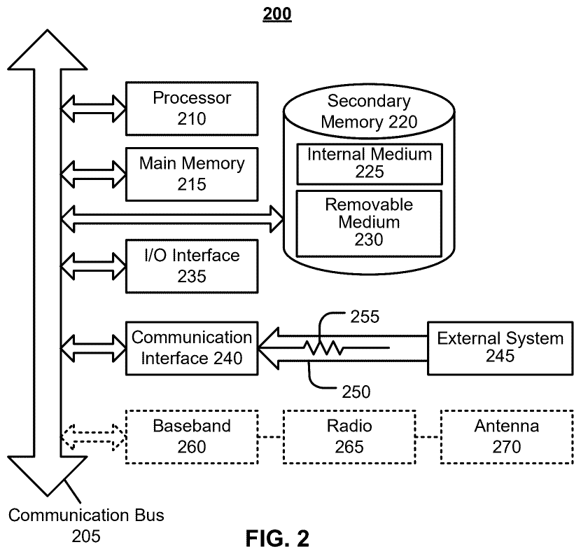

FIG. 2 illustrates an example processing system 200, by which one or more of the processes described herein may be executed, according to an embodiment. For example, system 200 may be used to store and/or execute server application 112, AI agent 160, AI model(s) 170, tool(s) 180, and/or may represent components of platform 110, user system(s) 130, third-party system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (V FDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCM CIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Process

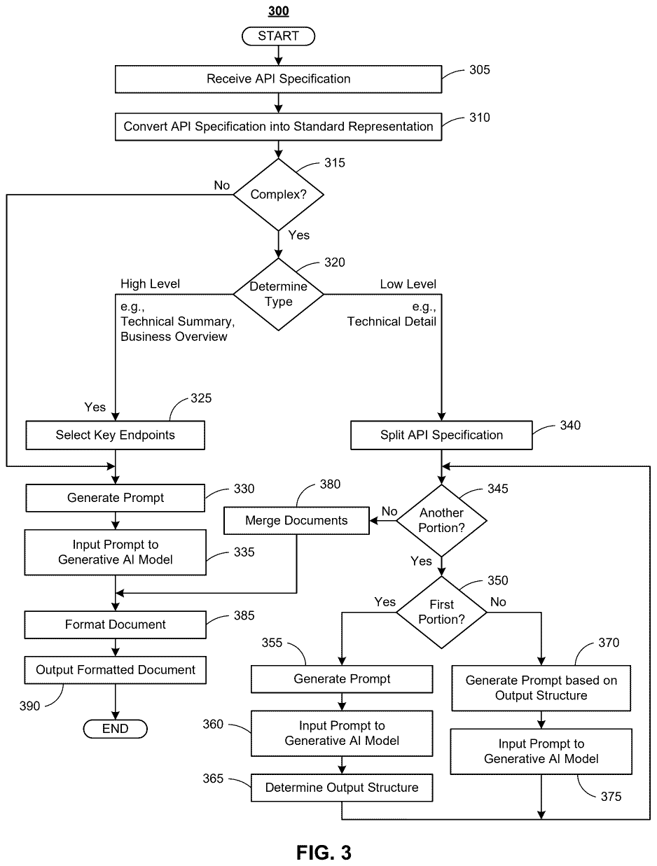

FIG. 3 illustrates an example process 300 for scalable generation of application programming interface (API) documentation, according to an embodiment. Process 300 may be implemented in server application 112, AI agent 160, or in a client application on user system 130. While process 300 is illustrated with a certain arrangement and ordering of subprocesses, process 300 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Process 300 may be executed whenever a new API documentation needs to be generated. For example, platform 110 may host and/or utilize a web crawler that automatically crawls the World Wide Web, identifying and collecting API specifications for third-party software applications. Each of these API specifications may be input to process 300 (e.g., in one or more batches) to generate one or more types of API documentation for each API specification. Alternatively or additionally, process 300 may be executed ad hoc, whenever an API documentation or new type of API documentation is needed or desired for a particular API specification. For example, a user could upload a new API specification from user system 130 to server application 112.

A plurality of types of API documentations are contemplated. A first type of API documentation may be a higher level, less detailed type of API documentation than a second type of API documentation. There may also be one or more additional types of API documentation with levels of detail between the first and second type. Each type of API documentation may encompass one or more use cases. For example, the first type of API documentation may be encompass at least a technical summary or business overview, and the second type of API documentation may encompass at least a technical detail. Each use case encompassed by the first type of API documentation may utilize a first framework for API-documentation generation, and each use case encompassed by the second type of API documentation may utilize a second framework that is different from the first framework.

A technical detail, which is the most detailed type of API documentation, may be targeted to software engineers or other technical users, and may describe, entirely or primarily in natural language, the precise technical information required for developers to understand, and software applications to interact with, the application programming interface, including the specific endpoints, methods, authentication and/or authorization protocol, and/or other API components. A technical summary, which is significantly less detailed than a technical detail and is intended to serve as a quick reference, may be targeted to product managers, and may describe, in natural language, a concise, high-level overview of the application programming interface's functionality and key features, and how to interact with the application programming interface. A business overview may be targeted to non-technical business decision-makers, and may describe, in natural language, a high-level overview of the purpose, value, and business use cases of the application programming interface, to provide a clear understanding of the purpose of the application programming interface (e.g., what it does) and the benefits (e.g., what problem it solves) of the application programming interface to the business. More generally, the technical detail will contain low-level technical information, the technical summary will contain, at most, high-level technical information, and the business overview will contain virtually no technical information. The plurality of uses cases of API documentation, generatable by the API-documentation generator, may comprise or consist of the technical detail, technical summary, and business overview, any two of these user cases, or any combination of one or more of these use cases with other use cases not specifically described herein. Alternatively, the API-documentation generator may only ever generate a single type of API documentation, which may be either the first type, the second type, or another type of API documentation, or a single use case, which may be either the technical detail, technical summary, or business overview, or another use case.

Initially, subprocess 305 may receive an API specification that defines an application programming interface for which an API documentation is to be generated. The API specification may define a plurality of endpoints (e.g., as a base URL and a plurality of paths), one or more methods, an output format for responses, an authentication and/or authorization protocol, and/or other API components. The API specification may be received from a user (e.g., via a user system 130), retrieved from database 114 or other database, received from a web crawler or other software application, and/or the like.

Subprocess 310 may convert the API specification into a standard representation that is used by the API-documentation generator. In particular, API specifications-especially those obtained via web crawling-will not necessarily be written or formatted in the same, common format. Thus, subprocess 310 may ensure that each API specification is either already in a standard representation, or else convert the API specification into the standard representation. As an example, the standard representation may be the standard representation defined by the OpenAPI initiative. The output of subprocess 310 may be a data object that defines the API specification in the standard representation. The data object may be in any suitable format, including J SON, XML, SOAP, or the like.

Subprocess 315 may determine whether or not the application programming interface, represented by the API specification, is complex, based on one or more criteria that are applied to the standard representation of the API specification. As an example, the one or more criteria may comprise the satisfaction of a respective threshold by a number of endpoints (or paths) and/or a number of tokens (e.g., characters, words, etc.) in the API specification. For instance, the number of endpoints in the API specification may be compared to a predefined endpoint threshold. Similarly, the number of tokens in the API specification may be compared to a predefined token threshold. When either the number of endpoints is greater than or equal to the predefined endpoint threshold or the number of tokens is greater than or equal to the predefined token threshold, subprocess 315 may determine that the API specification is complex. Otherwise, when the number of endpoints is less than the predefined endpoint threshold and the number of tokens is less than the predefined token threshold, subprocess 315 may determine that the API specification is not complex (i.e., is simple). Alternatively, the one or more criteria may consist of only the number of endpoints or only the number of tokens satisfying respective thresholds, or may comprise additional or different criteria. Conceptually, a complex application programming interface is any application programming interface for which the API specification is too large to be incorporated into a single call to an AI model 170 (e.g., a large language model). When determining that the application programming interface is complex (i.e., “Yes” in subprocess 315), process 300 may proceed to subprocess 320. Otherwise, when determining that the application programming interface is not complex (i.e., “No” in subprocess 315), process 300 may proceed to subprocess 330.

Subprocess 320 may determine the type of API documentation and/or use case to be generated for the API specification that was received in subprocess 305. In a preferred embodiment, the type of API documentation is determined from among a plurality of different types of API documentation, including at least a low-level (e.g., technically detailed) type of API documentation and a high-level (e.g., summary) type of API documentation. Each type of API documentation may comprise one or more use cases. Examples of use cases for a first, high-level type of API documentation include, without limitation, a technical summary or a business overview. An example of a user case for a second, low-level type of API documentation include, without limitation, a technical detail. In the illustrated embodiment, when the determined type of API documentation is a first type (i.e., a high-level type, such as a technical summary or business overview), process 300 performs a first process, comprising subprocesses 325-335. Otherwise, when the determined type of API documentation is a second type (i.e., a low-level type, such as a technical detail), process 300 performs a second process, comprising subprocesses 340-380. In other words, each type of API documentation (i.e., encompassing all use case(s) for that type of API documentation) may be associated with a different processing framework than any other type of API documentation. In an alternative embodiment, process 300 may only ever produce a single type of API documentation, in which case subprocess 320 may be omitted, and the “Yes” branch of subprocess 315 may be connected directly to subprocess 325 for a high-level API documentation or 340 for a low-level API documentation.

Subprocess 325 may select one or more endpoints from the plurality of endpoints defined in the API specification. In particular, subprocess 325 may identify a subset of endpoint(s) from the plurality of endpoints that are key to the application programming interface. Essentially, subprocess 325 identifies and shortlists key endpoints that capture the essence of the entire API specification and cover all important aspects of the API specification.

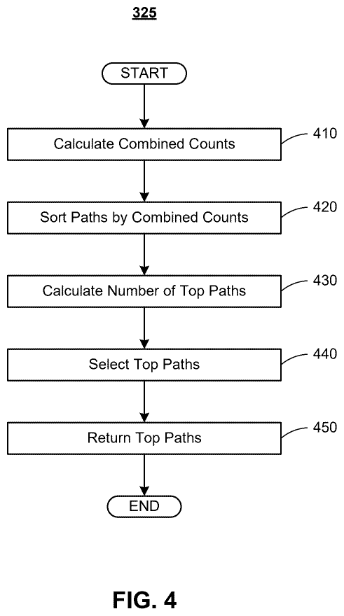

FIG. 4 illustrates an example of subprocess 325 for key-endpoint shortlisting, according to an embodiment. Initially, subprocess 410 may calculate a set of combined counts. In particular, for each path (or endpoint) defined by the API specification, subprocess 410 may calculate the combined count for that path as the sum of an operation count and a schema count. The operation count may be a count of the number of operations for the respective path, and the schema count may be a count of the number of schemas for the respective path. Essentially, these counts measure the engagement level with each path.

Subprocess 420 may sort the paths according to the set of combined counts that were calculated in subprocess 410. In particular, all of the paths defined by the API specification may be sorted in descending order based on their respective combined counts. Thus, the path with the highest combined count will be first in the sorted list, and the path with the lowest combined count will be last in the sorted list.

Subprocess 430 may calculate the number of top paths to select. The number of top paths to select may be calculated in any suitable manner. In an embodiment, the number of top paths to select is calculated as a predefined percentage (e.g., 5%, 10%, 15%, 20%, 25%, etc.) of the total number of paths defined by the API specification, rounded down to the nearest integer, and constrained to be less than or equal to a maximum number of top paths (e.g., fifteen).

Subprocess 440 may select the top paths from the sorted paths, according to the number of top paths that was calculated in subprocess 430. In particular, assuming that the paths are sorted in descending order in subprocess 420 and a number N of top paths to select is calculated in subprocess 430, N paths are extracted from the list of sorted paths, beginning from the first path in the list and ending with the Nth path in the list.

Subprocess 450 may return the top paths that were selected in subprocess 440. It should be understood that the returned top paths represent the selected endpoints output by subprocess 325.

Example pseudocode for an embodiment of subprocess 325 is provided below:

Key-Endpoints-Shortlisting Algorithm

```
Input:
  path_operation_count: dictionary of path-to-operation counts
  path_schema_count: dictionary of path-to-schema-reference counts
  paths: list of paths to consider
  percent: percentage of top paths to select
  max_paths: maximum number (e.g., 15) of paths in shortlist
Output:
  list of top paths based on combined counts
Pseudocode:
FUNCTION get_top_paths_by_percentage(path_operation_count,
path_schema_count, paths, percent):
  # Step 1: Calculate combined counts for each path
  CREATE dictionary combined_counts
  FOR each path IN paths:
    combined_counts[path] =
      path_operation_count[path]+path_schema_count[path]
# Step 2: Sort paths by combined counts in descending order
sorted_paths = SORT combined_counts by value in descending order
# Step 3: Calculate the number of top paths to return
num_top_paths = FLOOR(LENGTH(sorted_paths)*(percent/100))
num_top_paths = MIN(max_paths, num_top_paths)
# Step 4: Select top paths
top_paths = EMPTY list
FOR each path, count IN first num_top_paths of sorted_paths:
  ADD path TO top_paths
# Step 5: Return the result
RETURN top_paths
```

Subprocess 330 may generate a prompt, dynamically, based on the API specification. When subprocess 330 is being performed for a complex API specification (i.e., following performance of subprocess 325), the prompt may be generated based on the one or more endpoints, selected in subprocess 325. As discussed above, these endpoint(s) may consist of only the key endpoint(s), as determined by key-endpoint shortlisting. By incorporating just these key endpoint(s) into the prompt, the generative AI model, to which the prompt is input, will be focused on providing a concise and meaningful summary of the API specification, rather than on all the minutiae in the API specification, thereby ensuring clarity and relevance in the resulting API documentation, regardless of the complexity of the API specification.

Subprocess 330 may generate the prompt, using the key endpoint(s), for example, by inserting the key endpoint(s) into a predefined template. The predefined template may comprise a pre-conversation and/or post-conversation, which provide context and/or instructions for the generative AI model, and a placeholder into which the key endpoint(s) are inserted. The pre-conversation and/or post-conversation may define the role of the generative AI model (e.g., to summarize the key endpoint(s) into a technical summary. business overview, or other high-level use case), define an output structure for the generative AI model, and/or the like. It should be understood that a plurality of predefined templates may be provided, in which each of the plurality of predefined templates represents a different type of API documentation and/or use case. For example, a first predefined template may be provided for a technical summary, whereas a second predefined template may be provided for a business overview. Subprocess 330 may select the appropriate predefined template, from the plurality of predefined templates, based on the particular use case to be generated. It should be understood that the plurality of predefined templates may be similar and have a uniform structure, but will vary in terms of information related to the specific use case for which the API documentation is to be generated.

On the other hand, when subprocess 330 is being performed for a non-complex API specification (i.e., following the “No” branch from subprocess 315), the prompt may be generated based on the entire API specification. In this case, subprocess 330 may generate the prompt, using the API specification, for example, by inserting all endpoints, defined in the API specification, into the predefined template, which may be the same as or different than the predefined template used in the case of a complex API specification for the first type of API documentation and/or the same use case. Again, the predefined template may comprise a pre-conversation and/or post-conversation, which provide context and/or instructions for the generative AI model, and a placeholder into which the endpoint(s) are inserted. The pre-conversation and/or post-conversation may define the role of the generative AI model (e.g., to summarize the endpoint(s) in a technical summary or business overview), define an output structure for the generative AI model, and/or the like. Again, subprocess 330 may select the appropriate predefined template, from a plurality of predefined templates, based on the particular use case to be generated.

Subprocess 335 may input the prompt, generated in subprocess 330, to at least one generative AI model of AI model(s) 170, to produce the API documentation. For example, the prompt may be input to a large language model to produce the API documentation in a single call to the large language model. Additionally or alternatively, the prompt or an additional prompt could be input to a generative image model to produce a diagram or other graphical component of the API documentation. It should be understood that the API documentation comprises or consists of the output of the generative AI model(s) to which a prompt is input.

Subprocess 340 represents the beginning of an alternative, second process for a second, low-level type of API documentation. At the start of this second process, subprocess 340 may split the API specification into a plurality of portions. This splitting may be intelligent, to enhance efficiency and accuracy, with each portion being used to generate an API sub-document. At the end of the second process, the API sub-documents will be seamlessly merged into a final, cohesive, and uniform API documentation. This approach ensures both precision and streamlined workflow.

In an embodiment, subprocess 340 splits the API specification by creating a document for each of a plurality of subsets of one or more of the plurality of paths that are defined in the API specification. The plurality of subsets may collectively comprise all of the plurality of paths defined in the API specification, with or without overlap, and may each consist of the same predefined number of paths. In an embodiment, the predefined number of paths in each subset is one, such that each of the plurality of subsets consists of only a single one of the plurality of paths. Alternatively, the predefined number may be greater than one, such as two, three, four, five, ten, or the like. Subprocess 340 may then, recursively, for each of the plurality of subsets, for each path in the subset, parse the definition of the path to identify one or more API components of the path in the path's definition, and add all information for (e.g., all references to) the identified API component(s) from the API specification to the document for the subset. As a result, each of the documents will comprise, for each path in the subset of path(s) represented by that document, the path definition and all information from the API specification that is relevant to the path definition. Accordingly, all the information for a given path, within a subset of path(s), is packaged into a single document for that subset of path(s), representing a portion of the overall API specification. The output of subprocess 340 may be a list of the resulting plurality of subset-specific documents. It should be understood that each of these documents represents one of the plurality of portions of the API specification.

Subprocess 345 may determine whether or not another portion from the plurality of portions of the API specification, output by subprocess 340, remains to be processed. Essentially, subprocesses 345-375, will iterate through each of the plurality of portions. In particular, at a high level, subprocesses 345-375 will, for each of the plurality of portions, generate a prompt based on the portion, and input the prompt to at least one generative AI model of AI model(s) 170, such as a large language model, to produce an API sub-document. When determining that another portion of the API specification remains to be processed (i.e., “Yes” in subprocess 345), process 300 may select the next portion to be processed and proceed to subprocess 350. Otherwise, when determining that no more portions of the API specification remain to be processed (i.e., “No” in subprocess 345), process 300 may proceed to subprocess 380.

Subprocess 350 may determine whether or not the selected portion is the first portion to be processed. In other words, the first portion of the API specification may be processed differently or distinctly from all subsequent portions of the API specification. The reason for this is that, while the structure of the output of the generative AI model that will be used to generate each API sub-document can be influenced by the prompt, the structure may vary across different applications of the generative AI model. Thus, when the selected portion is the first portion, the structure of the API sub-document may be determined for the first portion, and when the portion is a subsequent portion to the first portion, the prompt that is used for the generative AI model may be generated based on the subsequent portion and the determined structure of the API sub-document for the first portion. This ensures format stabilization across the API sub-documents. Notably, when the plurality of portions of the API specification comprise a plurality of subsequent portions, the plurality of subsequent portions may be processed in parallel, after the first portion has been processed. When determining that the selected portion is the first portion (i.e., “Yes” in subprocess 350), process 300 may proceed to subprocess 355. Otherwise, when determining that the selected portion is a subsequent portion (i.e., “No” in subprocess 350), process 300 may proceed to subprocess 370.

Subprocess 355 may generate a prompt based on the selected, first portion of the API specification. Subprocess 355 may generate the prompt, using the endpoint(s) in the selected portion of the API specification, for example, by inserting the endpoint(s) into a predefined template. The predefined template may comprise a pre-conversation and/or post-conversation, which provide context and/or instructions for the generative AI model, and a placeholder into which the endpoint(s) are inserted. The pre-conversation and/or post-conversation may define the role of the generative AI model (e.g., to provide a technical detail of the endpoint(s)), define an output structure for the generative AI model, and/or the like. The predefined template may be similar to the predefined template used to generate the prompt in subprocess 330, but will comprise a different pre-conversation and/or post-conversation to instruct the generative AI model to produce a document containing more low-level technical detail of the application programming interface. In an embodiment in which the low-level type of API documentation has a plurality of use cases, subprocess 355 may select the appropriate predefined template, from a plurality of predefined templates, based on the particular use case to be generated.

Subprocess 360 may input the prompt, generated in subprocess 335, to at least one generative AI model of AI model(s) 170, to produce an API sub-document. The generative AI model(s) may be the same generative AI model(s) used in subprocess 335, or may be different than the generative AI model(s) used in subprocess 335. It should be understood that subprocess 360 may be similar or identical to subprocess 335. However, unlike subprocess 335, which outputs a full API documentation, the output of subprocess 360 is an API sub-document that represents documentation for a subset of paths (e.g., only a single path, a small predefined number of paths, etc.) in the API specification. Nonetheless, from the perspective of the generative AI model(s), subprocess 360 may be identical to subprocess 335.

Subprocess 365 may determine the output structure of the API sub-document that was output by the generative AI model(s) in subprocess 360. In particular, subprocess 365 may parse the API sub-document, output by subprocess 360, to identify one or more attributes (e.g., sections, organization, layout, etc.) of the structure of information within the API sub-document. While a requested structure may be defined in the prompt that was generated in subprocess 355 and input to the generative AI model(s) in subprocess 360, the requested structure may only be loosely defined and/or the actual output of the generative AI model(s) may not strictly adhere to the requested structure and/or may utilize “creative license.”

Notably, the first portion of the API specification may simply be the first one of the plurality of portions in the list of subset-specific documents that is output by subprocess 340. This first portion will generally comprise the first subset of path(s) that appears in the API specification. However, this does not have to be the case, and the first portion that is processed may be any arbitrary portion from among the plurality of portions of the API specification. The first portion is processed distinctly from subsequent portions, simply to obtain an output structure that can be applied to all subsequent portions. The particular output structure that is produced from the first portion is not important, as long as the same output structure is applied to all subsequent portions, so that the output structure is consistent across all API sub-documents.

Subprocess 370 may generate a prompt based on the selected, subsequent portion of the API specification and the output structure that was determined in subprocess 365. Subprocess 370 may be similar or identical to subprocess 355, except that the output structure is incorporated into the prompt. In particular, subprocess 370 may generate the prompt, using the endpoint(s) in the selected portion of the API specification and the attribute(s) of the output structure determined in subprocess 365, for example, by inserting the endpoint(s) and the attribute(s) of the output structure into a predefined template. The predefined template may comprise a pre-conversation and/or post-conversation, which provide context and/or instructions for the generative AI model, and a placeholder into which the endpoint(s) and output structure are inserted. The pre-conversation and/or post-conversation may define the role of the generative AI model (e.g., to provide a technical detail of the endpoint(s) in the output structure) and/or the like. The predefined template may be similar to the predefined template used to generate the prompt in subprocess 355, but may comprise a different pre-conversation and/or post-conversation to instruct the generative AI model to produce a document in the specific output structure that was determined in subprocess 365.

Subprocess 375 may input the prompt, generated in subprocess 370, to at least one generative AI model of AI model(s) 170, to produce an API sub-document with the same output structure as the API sub-document that was generated for the first portion of the API specification. The generative AI model(s) may be the same generative AI model(s) used in subprocesses 335 and/or 360, or may be different than the generative AI model(s) used in subprocesses 335 and/or 360. It should be understood that subprocess 375 may be similar or identical to subprocess 360.

Subprocess 380 may merge the API sub-documents for the plurality of portions of the API specification, output by subprocess 340, into the API documentation. Subprocess 380 may comprise processing each of the API sub-documents to ensure that each API sub-document has the same structure (e.g., sections, organization, layout, etc.) and/or is otherwise consistent with every other API sub-document. After processing each API sub-document, subprocess 380 may merge the API sub-documents into a single and full API documentation, comprising documentation for each of the plurality of endpoints in the API specification. The merge may comprise or consist of concatenating each of the API sub-documents to each other, for example, in the same order as the order in which their corresponding portions of the API specification were split from the API specification. In other words, the order of endpoints in the API documentation may be the same as the order of endpoints in the API specification.

Subprocess 385 may format the API documentation. In particular, the API documentation may be formatted according to a predefined visual style (e.g., fonts, headings, line spacing, etc.). The API documentation may also be converted into a particular output format, such as Hypertext Markup Language (HTML), XML, JSON, SOAP, Portable Document Format (PDF), Microsoft Word from Microsoft Corporation of Redmond, Washington, American Standards Code for Information Interchange (ASCII) text, Unicode (e.g., UTF-8, UTF-16, or UTF-32), and/or the like.

Subprocess 390 may output the API documentation, as formatted by subprocess 385. Subprocess 390 may comprise displaying the API documentation within a graphical user interface of user interface 115, storing the API documentation (e.g., in database 114) for future retrieval, providing access to (e.g., download of) the API documentation to user system 130 and/or target system 140 (e.g., at a unique URL, via software application 112 or a query of database 114 or other database, etc.), providing the API documentation to one or more downstream functions, publishing the API documentation within an online directory (e.g., accessible via server application 112 or an AI agent), automatically generating a connector step for integration processes based on the API documentation, and/or the like.

Notably, the utilization of generative AI models, such as a large language model, to generate the API documentation (e.g., in subprocesses 335, 360, and 375) enables the API documentation to contain information about the application programming interface even when such information is not present in the API specification received in subprocess 305. In particular, the large language model, when converting the API specification or key endpoints or portions of the API specification into API documentation with a consistent or standard output structure, is able to infer any missing information, necessary to fill information into the output structure, based on the information that is present. Accordingly, complete API documentations will be generated, even for incomplete API specifications.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
receive an application programming interface (API) specification that defines an application programming interface, including a plurality of endpoints;
determine a type of API documentation, to be generated for the API specification, from among a plurality of types of API documentation;
when the determined type of API documentation is a first type, perform a first process comprising
selecting one or more endpoints from the plurality of endpoints,
generating a prompt based on the selected one or more endpoints, and
inputting the prompt to a large language model to produce the API documentation;
when the determined type of API documentation is a second type, perform a second process comprising
splitting the API specification into a plurality of portions,
for each of the plurality of portions, generating the prompt based on the portion, and inputting the prompt to the large language model to produce an API sub-document, and
merge the API sub-documents for the plurality of portions into the API documentation; and
output the API documentation.

2. The method of claim 1, further comprising using the at least one hardware processor to:
determine whether or not the application programming interface is complex based on one or more criteria;
when determining that the application programming interface is complex, perform either the first process or the second process based on the determined type of API documentation; and
when determining that the application programming interface is not complex, without performing either the first process or the second process,
generate the prompt based on the API specification, and
input the prompt to the large language model to produce the API documentation.

3. The method of claim 2, wherein the one or more criteria comprise a number of the plurality of endpoints satisfying a predefined endpoint threshold.

4. The method of claim 2, wherein the one or more criteria comprise a number of tokens in the API specification satisfying a predefined token threshold.

5. The method of claim 2, wherein the one or more criteria comprise both a number of the plurality of endpoints satisfying a predefined endpoint threshold and a number of tokens in the API specification satisfying a predefined token threshold.

6. The method of claim 1, further comprising using the at least one hardware processor to format the API documentation prior to outputting the API documentation.

7. The method of claim 1, wherein the second process further comprises, for each of the plurality of portions:
when the portion is a first portion, determine a structure of the API sub-document for the first portion; and
when the portion is a subsequent portion to the first portion, generate the prompt based on the subsequent portion and the determined structure of the API sub-document for the first portion.

8. The method of claim 7, wherein the plurality of portions comprises a plurality of subsequent portions, and wherein the plurality of subsequent portions are processed in parallel.

9. The method of claim 1, wherein the first type of API documentation represents a plurality of use cases.

10. The method of claim 9, wherein the plurality of use cases comprises a technical summary and a business overview.

11. The method of claim 1, wherein the second type of API documentation represents at least one use case, and wherein the at least one use case comprises a technical detail.

12. The method of claim 1, wherein each of the plurality of endpoints represents one of a plurality of paths, and wherein selecting one or more endpoints from the plurality of endpoints comprises:
calculating a combined count for each of the plurality of paths;
sorting the plurality of paths according to the combined counts for the plurality of paths;
calculating a number of top paths to select;
selecting a set of one or more top paths from the sorted plurality of paths according to the calculated number of top paths to select; and
returning the selected set of one or more top paths as the selected one or more endpoints.

13. The method of claim 12, wherein, for each of the plurality of paths, the combined count for that path is calculated as a sum of a number of operations for that path and a number of schemas for that path.

14. The method of claim 1, wherein each of the plurality of endpoints represents one of a plurality of paths, and wherein splitting the API specification into a plurality of portions comprises:
generating a document for each of a plurality of subsets of one or more of the plurality of paths, wherein the plurality of subsets collectively comprise all of the plurality of paths; and
for each of the plurality of subsets, for each path in the subset,
parse a definition of the path to identify one or more API components of the path, and
add information for the identified one or more API components from the API specification to the document for the subset;
wherein each document represents one of the plurality of portions.

15. The method of claim 14, wherein each of the plurality of subsets consists of a single one of the plurality of paths.

16. The method of claim 1, wherein the method further comprises determining a use case for the API documentation, and wherein each generation of the prompt comprises selecting a predefined template for the prompt from a plurality of predefined templates, based on the use case.

17. The method of claim 1, wherein the method is implemented by an artificial intelligence (AI) agent hosted within a computing environment.

18. The method of claim 17, wherein the computing environment is an integration platform as a service (iPaaS) platform.

19. A system comprising:
at least one hardware processor; and
software that is configured to, when executed by the at least one hardware processor,
receive an application programming interface (API) specification that defines an application programming interface, including a plurality of endpoints,
determine a type of API documentation, to be generated for the API specification, from among a plurality of types of API documentation,
when the determined type of API documentation is a first type, perform a first process comprising
selecting one or more endpoints from the plurality of endpoints,
generating a prompt based on the selected one or more endpoints, and
inputting the prompt to a large language model to produce the API documentation,
when the determined type of API documentation is a second type, perform a second process comprising
splitting the API specification into a plurality of portions,
for each of the plurality of portions, generating the prompt based on the portion, and inputting the prompt to the large language model to produce an API sub-document, and
merge the API sub-documents for the plurality of portions into the API documentation, and
output the API documentation.

20. A non-transitory computer-readable medium having instructions stored therein, wherein the instructions, when executed by a processor, cause the processor to:
receive an application programming interface (API) specification that defines an application programming interface, including a plurality of endpoints;
determine a type of API documentation, to be generated for the API specification, from among a plurality of types of API documentation;
when the determined type of API documentation is a first type, perform a first process comprising
selecting one or more endpoints from the plurality of endpoints,
generating a prompt based on the selected one or more endpoints, and
inputting the prompt to a large language model to produce the API documentation;
when the determined type of API documentation is a second type, perform a second process comprising
splitting the API specification into a plurality of portions,
for each of the plurality of portions, generating the prompt based on the portion, and inputting the prompt to the large language model to produce an API sub-document, and
merge the API sub-documents for the plurality of portions into the API documentation; and
output the API documentation.
